(19) United States
(12) Patent Application Publication
(10) Pub. No.: US 2006/0047725 A1
(43) Pub. Date: Mar. 2, 2006

(54) Opt-in directory of verified individual profiles

(76) Inventor: Steven J. Bramson, Montreal (CA)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/212,481

(22) Filed: Aug. 26, 2005

Related U.S. Application Data
(60) Provisional application No. 60/604,853, filed on Aug. 26, 2004.
(60) Provisional application No. 60/634,041, filed on Dec. 7, 2004.

(51) Int. Cl. G06F 17/30

(52) U.S. Cl. 707/204

(57) ABSTRACT

The present invention provides a system and method for generating and accessing a verified individual profile on a computer network comprising a registration terminal for entering data into a plurality of profile fields in a profile for an individual, wherein the data in at least one profile field is verified by an agent using a verification method, and a profile database for storing the profile. The opt-in directory system also comprises a search utility for allowing a user to search the profile database for the profile via the network and a configuration utility for allowing the individual to edit and configure the profile via the network.

### RELATED APPLICATIONS

This application claims the benefit of priority of U.S. provisional application Ser. No. 60/604,853, filed Aug. 26, 2004, and U.S. provisional application Ser. No. 60/634,041, filed Dec. 7, 2004, which are relied on and incorporated herein by reference.

### FIELD OF THE INVENTION

The present invention relates to a system and method for generating and accessing a verified individual profile on a computer network.

### BACKGROUND OF THE INVENTION

In recent years, the increasing use of publicly accessible computer networks, such as the Internet, has resulted in an explosion in both the quantity and availability of personal information. However, because the Internet is largely unregulated, much of this information is provided without any assurance as to its accuracy or reliability. Moreover, poorly restricted access to such information has caused security concerns to be ubiquitous and identity theft to become increasingly common. Further, data mining and spam have led to an epidemic of lost productivity and invasion of privacy, and transaction fraud has been accepted as simply a cost of doing business. Accordingly, there exists a growing interest in society to provide solutions for preventing deception.

In this regard, while one may search certain public record databases for a cost, no single, general resource is currently available that enables a user to freely, confidently, and securely search for information about individuals. Despite this fact, a tool that provides free access to verified individual profiles would render numerous tasks, such as credit checks, security searches, employee screening, blind dating, and professional and social networking, easier to perform and more reliable.

One conventional method for freely providing individual profile information is for each individual to create a personal Internet homepage. Although such a homepage may be hosted anywhere, one problem with this method is that unless a user knows the specific address of the individual's homepage (or the individual's full name), the page is difficult to find. The individual can try to insure that his homepage is located by Internet search engines, such as those provided by Google® and Yahoo®, but this is a complicated and potentially expensive process. Also, because Internet search engines do not display search results in a comprehensive manner, instead providing only limited, non-standard information in the listing of results, it is often difficult to determine whether information about a particular, desired individual has been located, especially if the individual has a common name, e.g., “John Smith.” Moreover, Internet search engines often return irrelevant or only remotely related information in the search results which are difficult and time consuming to sift through when searching for a specific individual.

Another problem with the use of Internet homepages is the lack of a standard layout or presentation of information. The vast differences in the content and layout of such pages diminish their utility for those who must regularly search for information about individuals. In addition, many individuals who would like to be included in a general directory are not skilled in creating web pages for the Internet. Thus, those who do not have the necessary skills to create and maintain an attractive, useful homepage are excluded.

In addition to homepages, certain directories of individual profiles have been created for specific verticals, such as Internet white pages resources, Internet dating web sites, and social networking web sites. However, such conventional directories contain only limited profile information and are designed to locate individuals that meet only certain criteria. Searching for a specific, yet unknown individual based on small pieces of information is usually not possible with these systems. For example, a user may have only subtle knowledge of an individual's characteristics based on seeing a picture of the individual, casually meeting the individual, or speaking on the phone with the individual in the past. With conventional directories, the user cannot locate the individual without more qualitative information.

Of course, a major problem with both homepages and conventional directories is that the accuracy and authenticity of the information presented to the user cannot be verified. Because individuals commonly misrepresent themselves with false or misleading information, users are hesitant to trust information delivered by conventional systems.

In an attempt to provide more accountability for conventional directories, some governments have proposed initiatives to create national registries using national ID cards. However, these initiatives have come against great resistance from privacy advocates. Despite many practical uses, these programs show no signs of success. In any event, a national registry approach would likely result in the creation of different registries for each country and only enable searches based on known fields such as Social Security Number, full name, and birthday. Further, access to such systems would likely be restricted to only governmental organizations for official government applications and, as such, the associated solutions would not be available for commercial applications.

A need therefore exists for a system and method which provides an opt-in directory of verified individual profiles, wherein access to the directory is controlled to prevent identity theft, wherein the individual has control over what information is displayed to users of the system, and wherein the users can gather information about individuals easily and with confidence in its accuracy.

### SUMMARY OF THE INVENTION

The present invention answers this need by providing an improved system and method for generating and accessing a verified individual profile, wherein the individual can control the manner in which his profile is accessed and viewed and the user can have confidence in the profile information.

According to the present invention, an opt-in directory system is provided on a wide area network comprising a registration terminal for entering data into a plurality of profile fields in a profile for an individual, and a profile database for storing the profile. The data in at least one profile field is verified by an agent using a verification method. The opt-in directory system also comprises a search utility for allowing a user to search the profile database for the profile via the network and a configuration utility for allowing the individual to edit and configure the profile via the network.

In various embodiments of the present invention, the verification method used by the agent to verify data in at least one profile field comprises the step of reviewing a government-issued identification document or card presented by the individual to the agent; the step of asking the individual questions regarding an identity asserted by the individual to determine whether the identity is that of the individual; or the step of receiving electronic verification of the data from a third party.

In another embodiment of the present invention, additional data is entered into at least a second profile field and verified using a second verification method. The second verification method comprises the step of receiving a vouch, or an assurance, for the data from a voucher. In a still further embodiment, the voucher is an affiliate of an organization and the information regarding the individual identifies the individual as a present or former member of the organization.

In accordance with another aspect of the present invention, a method is provided for preventing identity fraud comprising the steps of receiving an identity from an individual; obtaining a photograph of the individual or biometric information from the individual; storing the photograph or biometric information on the opt-in directory system; asking the individual questions regarding the identity to determine whether the identity is that of the individual; and if the identity is not that of the individual, flagging the stored photograph or biometric information as having been received from a fraudulent individual.

In accordance with a further aspect of the present invention, a method is provided for verifying the identity of an individual comprising the steps of receiving information from the individual regarding an identity; accessing a profile of the individual via the wide area network, wherein the profile is stored on the directory system and comprises a plurality of profile fields having data, and wherein the data in at least one profile field was verified using a verification method; and comparing the verified data in the at least one profile field with the information received from the individual to determine whether the identity is that of the individual.

In accordance with a still further aspect of the present invention, a method is provided for allowing a user to search for and access individual profiles comprising the steps of receiving a search query submitted by the user via the wide area network, wherein the search query comprises at least one search term; providing the user with at least one individual profile, wherein the at least one individual profile comprises a plurality of profile fields having data, wherein the data in at least one profile field corresponds to the at least one search term, and wherein the data in at least one profile field was verified using a verification method; providing the user with access to the at least one individual profile via the wide area network; and communicating the verification method to the user on a field by field basis.

In accordance with yet another aspect of the present invention, a method is provided for verifying information in an individual profile comprising the steps of receiving a search query submitted by a user via the wide area network, wherein the user has a user profile stored in the directory system and a user profile score associated with the user profile, and wherein the search query comprises at least one search term; providing the user with at least one individual profile for an individual, wherein the at least one individual profile comprises a plurality of profile fields having data, wherein the data in at least one profile field corresponds to the at least one search term; providing the user with access to the at least one individual profile via the wide area network; allowing the user to create a vouch for data in at least one profile field in the accessed individual profile; and assigning a trust score to the vouch, wherein the trust score is based on the user profile score.

In accordance with an additional aspect of the present invention, a method is provided for allowing an individual to configure a profile for access comprising the steps of allowing the individual to define a group and associate the group with the profile, wherein the profile comprises a plurality of profile fields having data; allowing the individual to designate at least one designated profile field in the profile for display only to members of the group or for display only to non-members of the group; receiving a search query submitted by a user via the wide area network, wherein the search query comprises at least one search term; if the at least one search term corresponds to data in at least one profile field in the profile, allowing the user to view the profile; determining whether the user is a member of the group; and if the user is a member of the group, displaying the at least one designated profile field to the user if the at least one designated profile field was designated for display only to members of the group or hiding the at least one designated profile field from the user if the at least one designated profile field was designated for display only to non-members of the group.

Possible Uses.

The system and method of the present invention provide a solution that can be employed for many different uses. The following are some examples:
The opt-in directory system may be used for target marketing of goods and services to its members who can specify the specific interests they wish to be targeted for, if any. This opt-in approach is in contrast to spam, where people are targeted regardless of permission.
Contact management software can be created to use the system's profile ID numbers to retrieve an individual's (most) current address or to obtain an individual's public digital key.
Participating third parties can accept an individual's profile ID number in lieu of forcing the individual to enter lengthy registration information (such as during checkout for qualified e-merchants).
Individuals within a set degree of separation can be searched for based on their qualifications or potential interest in a project and invited to participate.
Membership in a club or current occupation can be confirmed. For instance, searching for an available doctor or lawyer of a specific type in the area would be greatly simplified.
With identity theft a constant threat, individuals may register to establish, record, and lock their personal information with a trusted source.
Organization and genealogy charts can be produced easily by locating individuals based on their confirmed relationship type.
A marketing/analytics organization can sponsor a profile field then make special offers to members, which would be contingent on demographic information being available when the profile is found based on a search of this field. A variety of interactions (such as a cookied site visit) can trigger the marketing/analytics company's search.
Individuals can put a link to their profile on other web pages for authentication purposes. For example, dating sites and chat rooms could insist on membership in the opt-in directory system to weed out anonymous users and ensure that people are presenting themselves honestly.
Portal search engines can pull information from profiles for display to their customers.
If they so desire, people can be found based on their car's license plate number or printing on their t-shirt, for example.
An alias profile ID number can be created and used to tag luggage.
Someone's role as a buyer can be verified to give them access to cost prices stored on suppliers' systems; and changing buyers would not require the suppliers to make changes to their systems, but instead the buyer's employer would make changes as is required in any case.
An individual verified to be an emergency medical doctor can be provided access to a second individual's medical records that were vouched for by the second individual's regular doctors. Such access to the second individual's medical records may be limited to members of an “authorized emergency room staff” group defined by the second individual. Further, a log that tracks access to the second individual's medical records may be kept so that any unauthorized access may be detected and reported.
The opt-in directory system can be used to form a “Fraud Prevention” alliance between credit card companies, banks, retailers and fulfillment carriers.
Retailers could access a limited profile of a customer that includes the customer's picture before agreeing to a sale by check or credit.
Using dynamic content, an analyst with a credit card company can see if a cardholder is actually in the store without having to make a call.
In addition to voice evidence, on-line merchants or tele-merchants could insist on a live video feed from a customer to be sure that the picture included on the customer's profile is that of the customer. The merchant can use contact information included in the profile for call back confirmation.
A profile score, an indicator of trustworthiness associated with the profile, can be used by retailers to better evaluate their transaction risk. Membership in the opt-in directory system could be mandatory for transactions over a certain threshold value.
Retailers or others may insist that delivery of goods or documents be made to a specific individual and include a profile ID number (in bar code or otherwise or already in the electronic manifest) for the individual to enable the courier to call up a picture of the individual on a mobile electronic device for verification.
Health insurance companies may use the opt-in directory system to prevent health insurance fraud by verifying a patient's identity, thereby preventing an uninsured patient from using an insured patient's identity.
The opt-in directory system may be used to provide quick and easy access to office buildings or hotels using the individuals profile ID number.
Using the search utility of the opt-in directory system, users can find individuals that provide specific services in the user's local area. Accordingly, professionals will be motivated to be included in the opt-in directory system so that they may be found by users seeking their services.
The opt-in directory system may be used as a certificate authority by allowing users to digitally sign profile information (providing certain knowledge of the source of a file and that it has not been changed), to encrypt profile information (allowing absolute private confidential communications), to authenticate (controlling access to internal and external systems and information), and to transact with other users (with non-repudiation).

The opt-in directory system of the present invention may be applied for entities other than individuals, such as businesses. Thus, finding the address of a nearby store that carries a particular product would be made easier than is currently possible with conventional systems. Similarly, a user would be able to find a restaurant nearby that serves a particular dish, a task that is next to impossible with conventional systems. Using the opt-in directory system of the present invention, which allows users to vouch for the store or to vouch for particular dishes, such tasks could even be performed with enhanced benefits.

Identity Theft Prevention.

In accordance with the present invention, identify theft is prevented using a means quite different from the standard approach of “prevent data from being stolen so that it can't be used.” Conventional company databases may protect against unauthorized access from external sources, but are routinely compromised at the very least by internal employees. Thus, the present invention takes the approach of “make stolen data useless for illegitimate transactions.”

The key factors to this solution are: (1) organizations using the opt-in directory system to verify identities; (2) individuals registering with the system and creating profiles to benefit from access to services and to lock their own identity; and (3) most importantly, providing sufficient risk and downside if someone tries to assume a false identity.

For instance, by taking sufficient biometric information during the registration process to uniquely identify an individual and then cross checking such information against all other (active and flagged) users, the present invention provides assurance that no person can be included in the opt-in directory system with more than one identity. Right away it becomes clear that even if a criminal forges government documents and manages to sufficiently study up on the identity they are trying to assume (for example, to pass the question based screening verification method), the criminal can only accomplish this once. Therefore, a criminal could only steal one identity and if he does so, he can never register his own real identity with the system (and honestly obtain services he may desire). Because the identity theft will likely be discovered by the victim or someone who knows the victim, the criminal would be very foolish to pose for a photograph and provide biometrics which can be used to identify him or her as the culprit. The criminal would not be able to travel by air or through borders and would need to lead a very low-profile life to avoid law enforcement that, using the present invention, has the means to identify perpetrators.

Because the world is increasingly security conscious, people are now accepting the fact that increased security comes at the expense of some privacy. As such, people are more willing to allow the taking of biometric readings beyond photographs such as fingerprints, iris scan, voice print, signature capture, and even DNA sampling. Many fingerprint and iris scan solutions are insufficient to uniquely identify an individual. For most applications this is not a problem because the level of risk is low. Also, in these applications the individual identifies himself or herself first with a username or physical identification document and then uses the biometrics as confirmation. As such, a criminal would have to know whose biometrics he matched before he could try to impersonate them. Consequently, only a combination of high-end biometrics readers providing absolute uniqueness will suffice to provide an identity theft prevention solution. In contrast, by ensuring that no two people in the profile database are the same, the present invention does not allow for an initial reading to compare against.

In one embodiment of the registration process, biometric information and a secure photo are taken of the individual, digitally signed and uploaded to the server before the question based screened verification method is initiated. Accordingly, if the individual fails the question based screened verification method, an irrevocable record of the crime is provided and the individual can be flagged from future access to the system.

In summary, fraud is typically perpetrated by those who think they can remain anonymous. Criminals that use forged documents usually do not want their pictures and biometrics taken. Further, honest citizens can be absolutely sure no one steals their identity by registering first.

Therefore, it is an object of the present invention to provide a method and system for generating and accessing a verified individual profile on a computer network that simplifies the process required to search for profiles and removes the plethora of inconsistent and untrustworthy information received in response to such a search.

Another object of the present invention is to provide a method and system for generating and accessing a verified individual profile on a computer network that provides the individual with control over the manner in which the individual's profile is retrieved by a search and displayed to a user.

A further object of the present invention is to provide a method and system for generating and accessing a verified individual profile on a computer network that enables a user to find an individual based on information other than the individual's name, address, phone number, or social insurance number, which are typically required to locate individuals using conventional systems.

A still further object of the present invention is to provide a method and system for generating and accessing a verified individual profile on a computer network that is complementary to existing businesses by enabling the business to verify the identity of an individual. Such businesses may include matchmaking companies, headhunting and employment companies, industry specific directory companies (e.g., “Who's Who”), alumni services programs, genealogy companies, Internet search engine providers, professional and social networking companies, Internet dating service providers, chat service providers, healthcare providers, travel agencies, and security and fraud prevention companies.

Embodiments of the present invention are described below by way of illustration. Other approaches to implementing the present invention and variations of the described embodiments may be constructed by a skilled practitioner and are considered within the scope of the present invention.

### BRIEF DESCRIPTION OF THE DRAWINGS

FIG. 1 is a relational diagram showing the elements of the system for creating an opt-in directory in accordance with the present invention.

FIG. 2 is a graphical user interface (“GUI”) for accessing and administering various features of the opt-in directory system in an embodiment of the present invention.

FIG. 3 is a GUI of a profile for an individual in an embodiment of the present invention.

FIG. 4 is a flow diagram of a vouch verification method in an embodiment of the present invention.

FIG. 5 is a flow diagram of the profile registration process, which includes the administration of at least one verification method, in an embodiment of the present invention.

FIG. 6 is a GUI for creating and submitting a search query to locate profiles in an embodiment of the present invention.

FIG. 7 is a GUI for presenting a user with the results of a search for profiles in an embodiment of the present invention.

FIG. 8 is a flow diagram of the search process in an embodiment of the present invention.

### DETAILED DESCRIPTION OF THE INVENTION

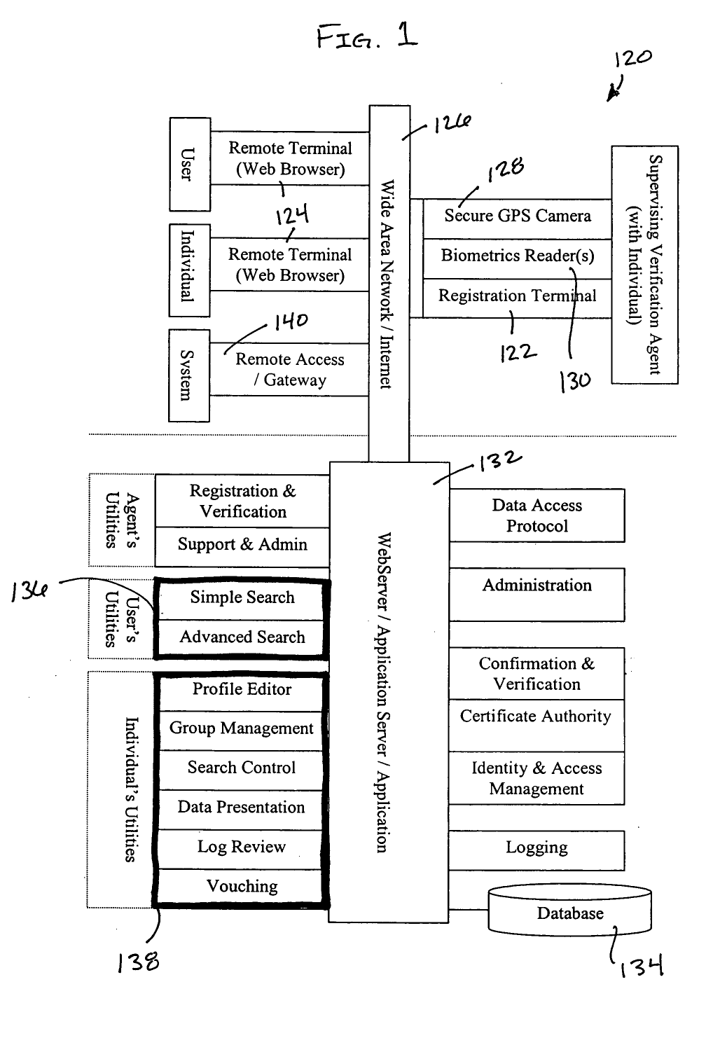

With reference to FIG. 1, an opt-in directory system 120 on a wide area network 126 in accordance with the present invention comprises a registration terminal 122 for entering data into a plurality of profile fields in a profile for an individual, wherein the data in at least one profile field is verified by an agent using a verification method, and a profile database 134 for storing the profile. The opt-in directory system 120 also comprises a search utility 136 for allowing a user to search the profile database 134 for the profile via the network 126 and a configuration utility 138 for allowing the individual to edit and configure the profile via the network 126.

Creating Profiles.

The first step for including an individual in the opt-in directory system 120 of the present invention, is to use either a remote terminal 124 or a registration terminal 122 on the computer network 126 to create a preliminary profile for the individual. The remote terminal 124 may be at any suitable location, such as the individual's home or office, and may be any suitable computing device on the network 126, such as a personal computer running a web browser. The registration terminal 122 is supervised by an agent at an authorized location and may also be any suitable computing device on the network 126. Authorized locations may include physical outlets, such as retail establishments or kiosks, or mobile locations so that agents can provide registration terminals 122 for individuals at their offices or homes.

In one embodiment, the individual uses the remote terminal 124 to create the preliminary profile and has the option of entering profile information into profile fields within the preliminary profile and editing profile information within the preliminary profile. After creating the preliminary profile using the remote terminal 124, the individual must register the preliminary profile using a registration terminal 122 under the supervision of an agent at an authorized location. In another embodiment, instead of using the remote terminal 124, the individual may use a registration terminal 122 to create a preliminary profile and then register the preliminary profile under the supervision of the agent at the authorized location. Each preliminary profile, whether created using the remote terminal 124 or the registration terminal 122, is assigned a temporary profile ID number by the system 120.

At the authorized location, the agent verifies information about the individual and registers the preliminary profile to create a (non-temporary) profile. The agent verifies information about the individual, such as the individual's name, address, driver's license number, social security number, and/or passport number, using at least one verification method (described below) before the information is entered into a plurality of profile fields in the individual's profile using the registration terminal 122. The use of agents, particularly agents that have been specially trained and screened, in creating the profiles adds accountability and provides users with a high level of trust in the opt-in directory system 120 of the present invention.

Once a portion of the individual's information is verified and entered into the profile, additional information may be entered into the profile. Information may be entered into the profile at the registration terminal 122 by hand, by scanning a document, through electronic means, or any other suitable means. Generally, only a small amount of information about the individual is entered into the profile at the registration terminal 122. Additional information is added to the profile by the individual after registration via the remote terminal 124 on the computer network 126, such as from the individual's home or office.

Each profile is assigned a profile ID number by the system 120 at the start of the registration process. The individual uses the profile ID number to access the profile for adding information to, editing, and configuring the profile via the computer network 126 (described below). In one embodiment, the profile ID number has an alphanumeric format, such as “brams1000000000,” that may be a combination of characters from the individual's name and a unique ten digit number. The ten digit number may be a hash of a sequential number so that the total number of individuals in the directory may not be estimated based on a newly issued profile ID number. Using an alphanumeric format that includes a ten digit number allows for over one billion individuals to be included in the directory system 120 of the present invention. Allowing some of the characters of the ten digit component to be alpha would allow for many more individuals to be included in the directory system 120 if necessary.

In certain embodiments, the individual may select his profile ID number for vanity or alias purposes. A vanity or alias profile ID number may be selected in addition to the individual's profile ID number and may be in a non-standard format. In still other embodiments, once a specific profile ID number is assigned, the same profile ID number is never reassigned, even if the profile identified by the profile ID number expires.

The profile ID number may be provided to the individual on an ID card using tokens, radio frequency identification (“RFID”) technology, bar code technology, smart card technology, or other suitable means. The ID card can be used by the individual to more securely access the administration graphic user interface (GUI) (described below) or by a user to more quickly access the profile with the individual present, as is required in many security sensitive situations. The profile ID number may also be included in text or bar code formats on the individual's business cards. Accordingly, the present invention allows for authentication of an individual through multiple means.

The agent also uses a camera to take a secure photo of the individual for inclusion in the profile. Each secure photo may be taken in front of a standard background for consistency and to allow a user to gauge height and head dimensions of the individual. The standard background may also be recognized by users and the public to indicate that the secure photo was taken by an authorized agent. A GPS receiver at the authorized location is used to determine the location, date, and time of the secure photo. This information, along with the ID number, is overlaid on the secure photo, thereby providing users with knowledge as to, for example, the age of the secure photo displayed in the profile. The GPS receiver, as well as time stamping and digital signing functionality, may be securely embedded and integrated with the camera.

In other embodiments, the agent obtains a voice recording from the individual for inclusion in the profile. In such embodiments, a voiceprint authentication system may be used to verify the individual's identity. Including the voice recording in the profile may assist users in identifying an individual when searching the database 134 (described below). For example, when a user mouses over a thumbnail photo of an individual, the system 120 may playback the individual's voice recording.

In still other embodiments, the agent obtains biometric information from the individual for verifying the individual's identity that may or may not be included in the profile. The biometric information may include measurements relating to the individual's face, fingerprints, hand geometry, handwriting, iris, or retina. In such embodiments, a biometric-based authentication system may be used to verify the individual's identity.

Once the agent creates the profile, the agent uploads the profile to a profile database 134. To ensure authorization, the agent may be required to enter a password to upload a profile. For additional security, the profile may be digitally signed. The process of digitally signing a photo may be performed using public key software to enable users to confirm that the secure photo has not been tampered with and that the date, time, and location identified on the secure photo is accurate.

A confirmation routine may be executed which confirms that the profile being uploaded to the profile database 134 was created using an authorized registration terminal 122 and that the secure photo was recently taken. The confirmation routine may also perform various error detection functions, such as determining whether the profile contains key information, such as a driver's license number, a passport number, or biometric information that matches the key information contained in another profile previously uploaded to the profile database 134. The confirmation routine may also access external databases to verify information in the profile. In another embodiment, the confirmation routine creates a confirmation message and sends the confirmation message to the individual to confirm that he authorized the creation of the profile.

After the profile has been uploaded to the profile database 134 and approved by the confirmation routine, the profile is made publicly available via a search utility 136, described in greater detail below.

Editing Profiles.

In accordance with the present invention, the opt-in directory system 120 (FIG. 1) comprises a configuration utility 138 on a server 132 for allowing an individual to edit and configure his profile via the computer network 126. In one embodiment, a username and a password are created for the individual upon creating his profile. In such an embodiment, the configuration utility 138 provides the user with a login GUI prior to allowing the individual to edit or configure the profile. The login GUI accepts the username and password from the individual for authentication and security purposes. In other embodiments, additional security may be provided using a token or a biometric-based authentication system.

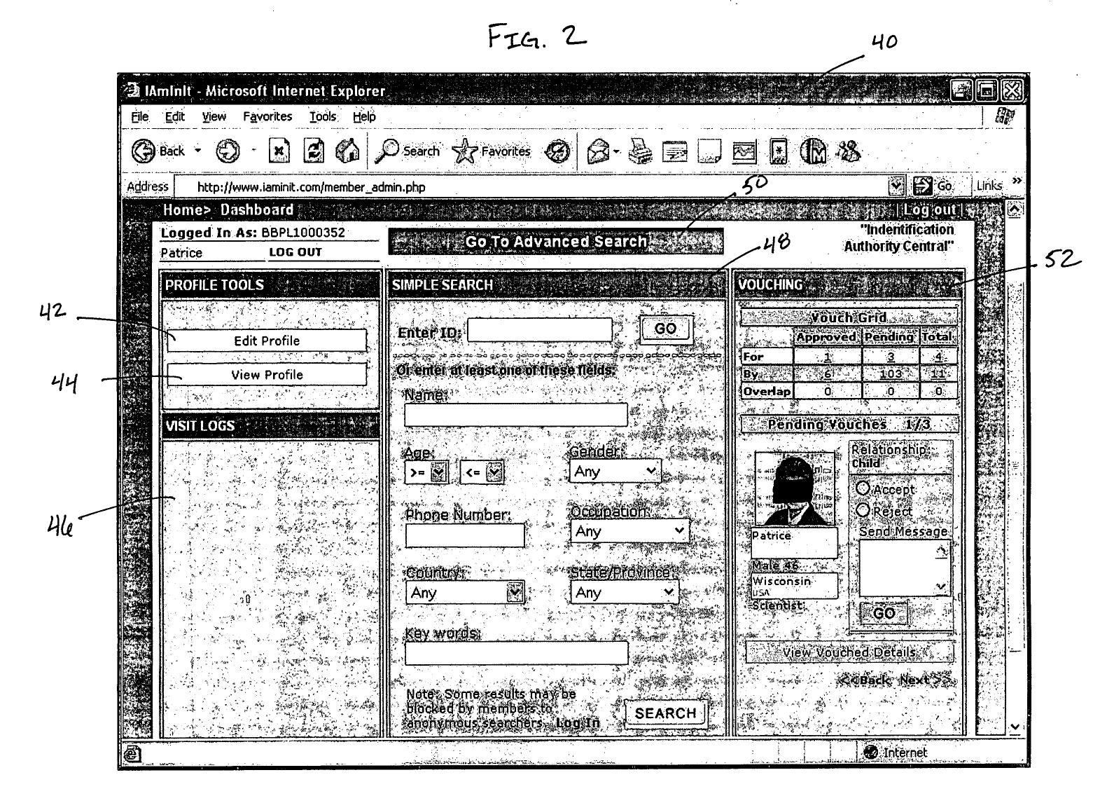

The configuration utility 138 provides the individual with administration GUIs for adding information to the profile, for editing information previously entered into the profile, for viewing and configuring the profile, and for accessing various features of the opt-in directory system 120. With reference to FIG. 2, one embodiment of a member administration GUI 40 is shown. (The individuals depicted in the figures are for display purposes only and certain features have been redacted for privacy reasons. Their inclusion in the present application should not be construed as an endorsement or support for, or affiliation with, the present invention or the inventor). From the member administration GUI, the individual may select an edit profile button 42 to access an edit profile administration GUI and edit and configure his profile, select a view profile button 44 to access a view profile administration GUI and view his profile, use a visit logs field 46 to access a log showing historical access information for the profile (described below), enter search terms into a search field 48 to search for profiles stored in the profile database 134 (described below), select an advanced search button 50 to access an advanced search GUI and perform an advanced search for profiles stored in the profile database 134 (described below), and use a vouching field 52 to view vouch information and to accept or reject vouches (described below).

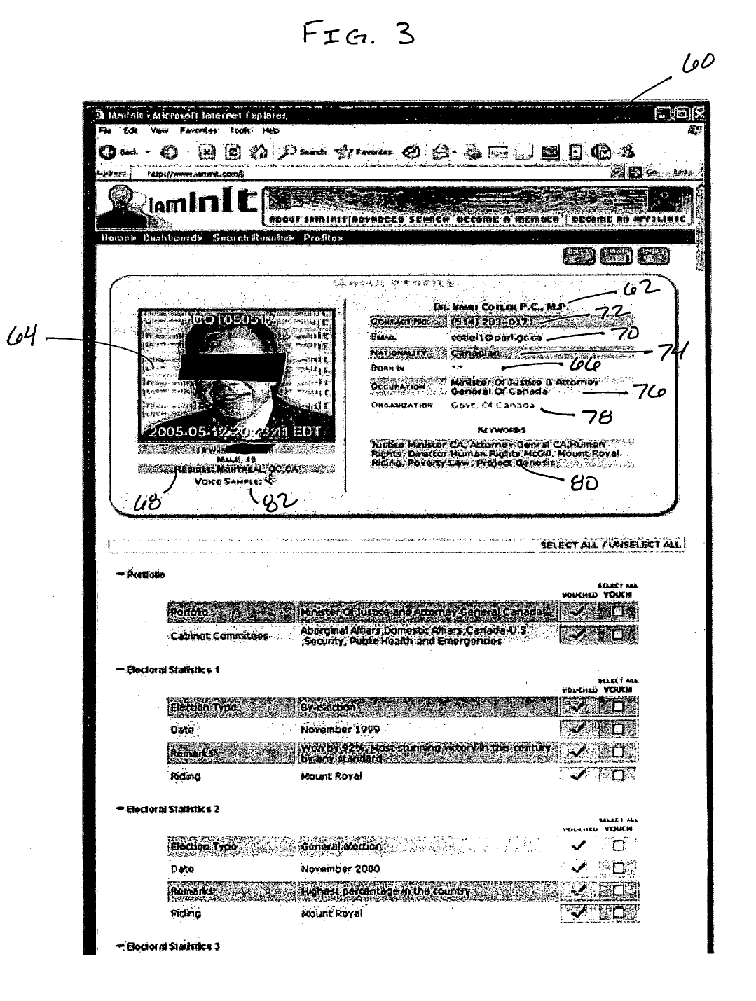

Profile information is entered into the profile and presented to the individual via the plurality of profile fields. With reference to FIG. 3, one embodiment of a profile 60 is shown. The profile fields within the profile 60 comprise a name field 62 for entering and displaying the individual's name and a secure photo field 64 for uploading and displaying the individual's secure photo taken during creation of the profile, or during an update session with the authorized agent. The profile fields may also comprise, but are not limited to, a birth date field 66, a residence field 68, an address field, an email field 70, a phone number field 72, a nationality field 74, a passport number field, a driver's license number field, a social security number field, occupation fields 76, employment fields, education fields, organization fields 78, hobbies fields, key words fields 80, a voice sample field 82, web links fields, references fields, industry specific information fields, membership fields, relationship fields, and biometric fields. The profile fields are configured to accept a variety of data types, including logic, text, numerical, pull down fields, and electronic files. It will be appreciated that the profile fields may comprise any suitable field for retaining information that may be of importance to users of a directory system such as the present invention.

An entry date indicator may be associated with each profile field to communicate to the user when the individual added or edited the information in the profile field. The entry date indicator serves to establish or disestablish trust in the profile field when the profile field and/or other profile fields have received vouches (described below).

In one embodiment, the edit profile administration GUI includes one or more templates comprising a plurality of information sets (“infosets”) having profile fields that are relevant to previously entered profile information, such as occupation. A template that has been filled in by the individual is displayed to users of the system that access the profile as collection of infosets. The individual may be allowed to add infoset templates based on desire and interest. When information is entered into one profile field, additional profile fields may be presented to the individual based on the profile field or on the information entered.

In another embodiment, the edit profile administration GUI includes standardized profile fields into which only predetermined information may be entered. For example, names of schools, employers, or organizations may be selected from a predetermined list to ensure proper spelling. The use of standardized fields prevents the individual from adding erroneous information to the profile that would decrease the individual's chance of being located by a search of the profile database 134.

In still another embodiment, at least one administration GUI includes a log showing historical access information for the profile. The log may include the time and date at which another user accessed the individual's profile. The log may also include other information to aid in identifying the user who accessed the profile, such as name, profile ID number, a thumbnail photo, or membership information. In addition, the log may include historical information relating to the profiles that the individual, acting as a user, has accessed or viewed using the opt-in directory system.

Storing Profiles.

The profile information is stored vertically in the profile database 134 (FIG. 1) that is distributed over the wide area network 126 to a plurality of database systems with more than one agent administering the database systems. Accordingly, the profile information is protected against unauthorized internal access, such as from information technology agents having a decryption key. Using such a configuration, a compromise of any one or two database systems is unlikely to provide the perpetrator with profile information because the decryption keys for the database systems will not be common. The database systems may also be configured to overlap data so that the loss of any one database system will not result in a loss of profile information, and any corrupted data may be identified. Although the database systems will be physically separate and backed up in real time, there is a limit to the distribution as performance would be negatively affected (as such, P2P (peer-to-peer) is not a realistic solution at this time).

The profile database 134 may be on the server 132 and comprises an ID table, an INFO table, a plurality of content tables, a DATA_TYPE table, and a FIELD table. The ID table is used to assign the next distinct indexed primary key ID for each entry in the other tables such that the same key ID is not found in more than one table. An ID field of the ID table is incremented as data is added. Data can be of various types including: address, big integer, date-time, double, file, float, graphic, integer, text, and tiny integer. For efficiency data is preferably stored in tables designed for the particular data type. Accordingly, the following corresponding content tables may be provided: a CONTENT_ADDRESS table, a CONTENT_BIG_INTEGER table, a CONTENT_DATE_TIME table, a CONTENT_DOUBLE table, a CONTENT_FILE table, a CONTENT_FLOAT table, a CONTENT_GRAPHIC table, a CONTENT_INTEGER table, a CONTENT_TEXT table, and a CONTENT_TINY_INTEGER table.

Amongst other fields, the INFO table may contain a USER_ID field that corresponds to the individual's profile, an INFO_SET_ID field that is used to define a collection of INFO table entries into which the information belongs for organization purposes in collection and display, a DATA_TYPE_ID field that identifies which content table contains the data, and a CONTENT _ID field that points to the specific entry in the appropriate content table that contains the data. The USER_ID field can be mapped to the profile ID number but need not contain the profile ID number. Accordingly, each profile may include more than one record in the INFO table, the number corresponding to the number of profile fields populated for the profile. The INFO table may also include a Status Flag Field, an Effective Start Date Field, an End Date Field, and/or an Entered Date Field for storing various attribute information relating to the profile information on a field by field basis

The FIELD table is used in connection with providing infoset templates to ensure entries are within an allowed range or are of an approved selection. The FIELD table is also used to further define the content type, for example that a specific CONTENT_TEXT entry contain a web link URL. Using this approach has the additional advantage of allowing content table entries to be pointed to by multiple INFO table entries and therefore multiple individuals. For instance, a school address would only have to be in the CONTENT_ADDRESS table once.

By determining the type of profile information in each Information Field, using the DATA_TYPE_ID field common to the INFO Table, the FIELD table and the DATA_TYPE table, the system 120 is configured to communicate the information in each profile field to the user in its appropriate format. For example, the INFO table will point to electronic files, such as spreadsheets, when an electronic file is referenced which then may be displayed or have a link provided. Similarly, the INFO Table will indirectly point through to an external source, such as a cellular phone company's mobile 911 locator service, when the contents of the CONTENT_TEXT field is identified as a dynamic external field, thereby causing the profile information to be downloaded in real time.

Facilitating Access to Profiles.

In one embodiment of the present invention, the opt-in directory system 120 (FIG. 1) comprises an application programming interface (“API”) for facilitating access to the profile information stored in the profile database 134 via external systems on the wide area network 126. The API of the present invention facilitates access to profiles via any suitable physical or wireless connection to the network 126 and using any suitable computing device, such as a computer, a mobile phone, or a PDA.

Using the API, third parties may develop software to communicate electronically with the opt-in directory system 120 to access, edit, and configure profiles stored in the profile database 134. For instance, an external company may wish to ensure that every individual at the company is included in the profile database 134 or to create new profiles for its employees if necessary. The company may use the API to integrate the functionality into their systems themselves or they may use third party software that has already done so.

Using the API, external clients and clients using protocols other than HTTP may access the profiles stored in the profile database 134 through a gateway 140. In one embodiment, the API uses the system's Data Access Protocol (“DAP”) to communicate (which is based on industry standard technology such as XML and Web Services). It will be appreciated that software tools and algorithms for interfacing the opt-in directory system 120 with all conventional programming environments may be made available.

The opt-in directory system 120 is configured to prevent data mining (described below) but at the same time provide maximum utility to the users attempting to legitimately access a profile. For example, a third party may wish to provide a service where a user could enter an individual's profile ID number (or phone number) on the user's touch tone phone to access the profile using text-to-speech technology. In another example, a custom Internet search engine may be configured to search the profile database 134 and return profile information to the user. Similarly, a custom Internet search engine may be configured to allow a consolidator or publisher of digital content to provide access to profiles by cellular phone users in a specific industry. The API may be used to develop an off-line profile editing tool.

Controlling Access to Profiles.

In one embodiment of the present invention, the opt-in directory system 120 (FIG. 1) comprises an access control utility for controlling user access to the profiles stored in the profile database 134 via the wide area network 126. The access control utility is configured to perform velocity checking from incoming IP addresses and message screening to filter spam. The access control utility may also be configured to require access tokens and/or employ other authentication mechanisms before complying with requests. The access control utility may be configured to prompt the user to enter text displayed graphically to control access to specific utilities (such as sending web based email) and prevent automated, brute force access to the opt-in directory system 120.

The access control utility may also be configured to throttle data access using an artificial intelligence pattern recognition algorithm that looks at the incoming IP addresses, request specifics, rates of requests, user IDs, and other variables to determine if the requests are legitimate or from undesired data mining operations. It will be appreciated that the algorithm may change as challengers become more clever in their hacking techniques.

In one embodiment, the access control utility is configured to provide trusted federated identity partners (described below) with more freedom of access to profiles stored in the profile database 134. In such cases, the risk to customer data privacy is minimal because any profiles delivered would have been approved for viewing by anonymous searchers.

Verifying Profile Information.

As previously described, when a profile is registered, an agent verifies, using one or more verification methods, at least a portion of the individual's information that is entered into the registration terminal 122 and included in the individual's profile. In addition, certain verification methods may be employed to verify information about the individual after the profile has been created.

In accordance with the present invention, a verification icon is associated with each profile field in the profile that includes information that has been verified using a verification method. The verification icon is used to communicate to the user the particular verification method, or verification methods, by which the information in the profile field was verified and in some cases an indication of confidence. By clicking on the verification icon, the user is provided with details regarding the verification method used to verify the information in the associated profile field. The verification icon may be updated each time the profile is displayed.

Because the present invention communicates the particular verification method to users on a field by field basis, rather than for the profile as a whole, users are less likely to be mislead by inaccurate information. When a verification method is used to verify a profile as a whole, or relatively large amounts of information in a profile, there is a greater chance that at least a portion of the profile information was not actually verified, e.g., was overlooked, and is inaccurate. By contrast, when a verification method is used to verify a specific field of information and is communicated to the user on a field by field basis, the user can be more assured that the particular information in the associated profile field was in fact reviewed and verified.

The verification methods used to verify information about an individual may include, without limitation:

Official Documentation Presented

An official documentation presented verification method comprises the step of reviewing a government-issued identification document or card presented by the individual to the agent at the authorized location. Accordingly, when a profile includes information in a profile field that has been verified using the official documentation presented verification method, a verification icon is associated with the profile field that, when selected by a user, will communicate to the user details regarding the document or card used to verify the information. For example, if the information in the profile field comprises the individual's name, selecting the verification icon will present the user with information, such as “United States Passport Expiring Jan. 1, 2010,” or “Georgia Driver's License,” to inform the user how the individual's name was verified. Selecting the verification icon may also present the user with the identity of the agent who reviewed the document or card.

Question Based Screened

A question based screened verification method comprises the step of asking the individual questions regarding the individual's asserted identity at the authorized location to determine whether the individual's asserted identity is correct. Companies such as Verid Inc. use similar methods to provide basic identity verification services. The questions may be derived from external sources, such as credit reports from a third party, and may inquire into historical information regarding the individual's asserted identity, such as previous addresses. In one embodiment, the question based screened verification method is used to confirm the identity of an individual and is a complement to the official document presented verification method. In such an embodiment, a profile field such as a date of birth field would not be specifically verified using the question based screened verification method. The question based screened verification method would be associated with a section of the individual profile and the verification icon would be displayed with the individual's secure photo.

Accordingly, when a profile includes information in a profile field that has been verified using the question based screened verification method, a verification icon is associated with the profile field that, when selected by a user, will communicate to the user details regarding the questions used to verify the information and how the individual fared in answering the questions. For example, selecting the verification icon will present the user with information, such as “Scored 80% with an expectation of 90% and minimum pass of 75% using 2 passes of XYZ Inc.'s Knowledge Basing Screening System,” to inform the user how the individual's identity was verified. Selecting the verification icon may also present the user with the identity of the agent who supervised the automated questioning on the registration terminal 122.

In another embodiment, when the question based screened verification method has been used a confidence level indicator is associated with the verification icon used to communicate to a user the verification method. The confidence level indicator communicates a confidence level which is calculated by a confidence level utility and assigned to the profile verified by the question based screened verification method. The confidence level may be updated each time a profile is displayed.

Federated Identity

A federated identity verification method comprises the step of receiving electronic verification of information from a third party. The third party may be a federated identity partner with the administrator of the opt-in directory system 120. It will be appreciated that federated identity management is a growing industry standard that enables organizations to share trusted identities. One application of federated identity is to enable an individual to log into an application on one domain and then move to another application on another domain without having to log in again. Accordingly, when a profile includes information in a profile field that has been verified using the federated identity verification method, a verification icon is associated with the profile field that, when selected by a user, will communicate to the user details regarding the third party used to verify the information. For example, if the information in the profile field comprises the individual's employer, selecting the verification icon will present the user with information, such as “Verified by Acme, Inc., a Federated Identity Partner, Human Resources Department, Suzie Jones, Employee 12345,” to inform the user how the individual's employer was verified.

In one embodiment, existing federated identity and access management software may be implemented to verify the identity of employees, partners, or customers and to control which applications and data users may access and distribute over the wide area network 126. Given that phishing is being used with greater frequency to intercept passwords, multi-factor authentication is commonly used with such solutions to protect against on-line fraud. Because password management is overwhelming (and typically insecure as people use the same username and password at many different web sites) the present solution addresses the problem by allowing for a single sign-on. A benefit of single sign-on is that the user would only need to carry one token device to securely access all services.

Vouch

A vouch verification method comprises the step of receiving a vouch or assurance of information regarding the individual from a voucher. For instance, a vouch verification method may consist of a voucher accessing an individual's profile and vouching for information in a profile field, an infoset, or all fields in the profile by selecting a vouch button associated with the profile field, infoset or all fields, respectively. In one embodiment, the individual is allowed to accept, reciprocate, or reject the vouch.

Accordingly, when a profile includes information in a profile field that has been verified using the vouch verification method, a verification icon is associated with the profile field that, when selected by a user, will communicate to the user details regarding the voucher, or vouchers, that verified the information. For example, if the information in the profile field comprises the individual's college, selecting the verification icon may present the user with information, such as “Confirmed by: Jill Smith, Dean of Students; James Dean, Friend,” to inform the user how the individual's college was verified. Selecting the verification icon may also present the user with the date the vouch was made, additional information about the voucher, or vouchers, such as a profile ID number, a thumbnail photo, or a mini biography, and a link to the voucher's profile.

In one embodiment, the voucher vouching for the information must designate a relationship type that describes his relationship with the individual that gives the voucher the ability to vouch for the information. Accordingly, when the vouch verification method has been used one or more relationship type indicators (and quantities of each) may be associated with the verification icon(s) used to communicate to a user the verification method. The relationship type indicator is used to communicate the relationship type between the voucher(s) and the individual.

In another embodiment, when the vouch verification method has been used a trust score indicator is associated with the verification icon that is related to a profile field or infoset and is used to communicate to a user the verification method. The trust score indicator communicates a trust score that is calculated by a trust score utility and assigned to the vouch. The trust score utility uses a public key encryption technology to securely sign a specific vouch. A vouch from a voucher that has a profile with a high profile score (described below) carries more weight than a vouch from a voucher having a profile with a lower profile score.

Calculating the trust score comprises assigning each profile field a profile field weight. Profile fields that contain key information, such as the name field or the secure photo field, are assigned more weight than other profile fields. The trust score calculated by the trust score utility is dependent on whether the individual and the voucher have vouched for each other's profile information or whether the vouch was independently provided by the voucher. The trust score may also be dependent on whether the voucher has received vouches from others, besides the individual, with regard to the voucher's profile information. Such indirect vouches have a lesser influence on the trust score than direct vouches. Indirect vouches may be tracked for trust score calculation purposes across several degrees of separation from the individual.

The trust score utility is configured to organize individuals into a hierarchy of trust such that, at each progressive degree of separation from the individual there would likely be an increasing number of vouches. At each degree of separation a most trusted individual is designated. In one embodiment, the trust score utility is configured to identify a link between any two individuals by as few degrees of separation as possible. In another embodiment, the trust score utility is configured to identify a link between any two individuals by the highest trust score. The trust score utility may also adhere to conditions, such as ensuring contact information within degrees of separation. Accordingly, the social networking functionality of the present invention can be used to simplify the introduction of the individual to another user they would like to meet.

The trust score utility uses regression modeling to calculate the trust score, using the profile field weights and degrees of separation as explanatory variables in a regression function. The explanatory variables may be dynamically updated.

In one embodiment, the trust score is more greatly influenced by the quality of vouches rather than quantity; in other words, more vouches does not necessarily result in a higher trust score. It will be appreciated that the greater the number of users that utilize the vouch functionality, the more useful the trust score becomes and the more confidence will be imparted in the opt-in directory system 120.

The vouches of the individual's profile information and the trust score assigned to each vouch are used to calculate and assign a profile score to the individual. The profile score, in turn is a factor used by the trust score utility to calculate the trust score assigned to vouches made by the individual with regard to information in other users' profiles. If the individual's profile score drops below a threshold, the individual is no longer trusted and any vouches made by the individual are adjusted accordingly and may reduce their trust score. The profile score is also calculated using regression modeling.

In another embodiment, if the individual edits information in a profile field for which a vouch, or vouches, has previously been received, the vouch, or vouches, are set to invalid. For a vouch to be valid, the date of the vouch must be later than the date the information was entered into the profile field. In such an embodiment, the individual may be notified that any invalid vouches need to be updated.

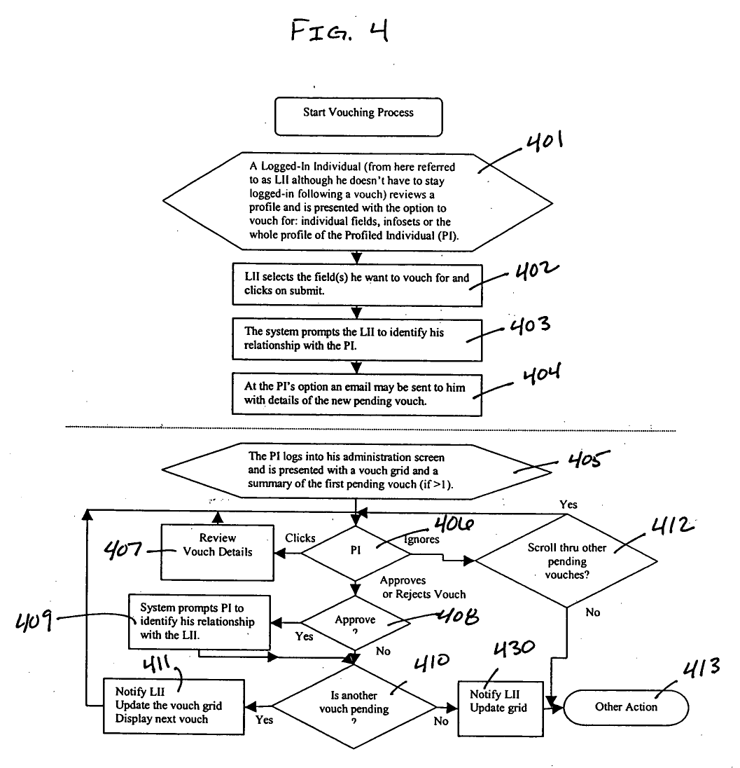

With reference to FIG. 4, an embodiment of the vouch verification method will be described. At step 401, a voucher, or “logged-in individual,” is presented with and reviews a profile of an individual via the network. In addition, the voucher is presented with the option of vouching for at least one profile field and/or infoset, or the profile as a whole. At step 402, the voucher selects the profile field, infoset, or profile to vouch for and submits a vouch. At step 403, the system prompts the voucher to designate a relationship type to identify the voucher's relationship with the individual. At step 404, if the profile is so configured, the system sends the individual with an email to notify the individual that a vouch has been submitted and to provide the individual with details of the vouch.

At step 405, the individual accesses the profile via an administration GUI and is presented with a vouch grid and a summary of the vouch (or the first submitted vouch if more than one vouches have been submitted). The vouch grid, which may be updated upon login, shows the individual how many vouches the individual has made and the state of such vouches, e.g., pending, approved, rejected, as well as how many vouchers have vouched for profile information in the individual's profile and the state of such vouches. If there is an overlap (where the individual and the voucher have vouched for each other), then such information is also presented to the individual in the vouch grid. Selecting a box in the vouch grid will present the user in a listing of vouches (with thumbnail pictures) in a particular state for quickly processing vouches.

At step 406, the individual is provided the option of selecting the vouch, approving or rejecting the vouch, or ignoring the vouch. If the individual selects the vouch, details regarding the vouch are provided at step 407, and the individual may scroll through any remaining vouches at step 412.

If the individual approves the vouch at step 408, the system prompts the individual to designate a relationship type that identifies the individual's relationship with the voucher at step 409. After the individual designates a relationship type at step 409, or if the individual rejects the vouch at step 408, the system determines at step 410 whether another vouch is pending. If another vouch is pending, the voucher is notified as to whether the vouch was approved or rejected, the vouch grid is updated, and the next vouch is displayed to the user at step 411. From step 411, the process loops back to step 406. If no other vouches are pending, the voucher is notified as to whether the vouch was approved or rejected and the vouch grid is updated at step 430. From step 430, the individual proceeds to step 413 to exit the process and perform another action.

If the individual ignores the vouch at step 406, the user is presented with the option of scrolling through any other pending vouches at 412. If the user selects to scroll through other pending vouches, the process loops back to step 406. If the user selects not to scroll through other pending vouches, the individual proceeds to step 413 to exit the process perform another action.

In one embodiment, the individual and the voucher can cancel a vouch in either direction or have a vouch expire automatically. In such an embodiment, the other party may be notified of such actions.

Membership Verified

A membership verified verification method comprises the step of receiving a vouch of information regarding the individual from a voucher, wherein the voucher is an affiliate of an organization and the information regarding the individual identifies the individual as a present or former member of the organization. Thus, the membership verified verification method is one example of the vouch verification method. Accordingly, when a profile includes information in a profile field that has been verified using the membership verified verification method, a verification icon is associated with the profile field that, when selected by a user, will communicate to the user details regarding the affiliate, or affiliates, of the organization that verified the information, and/or details regarding the individual's membership. For example, if the information in the profile field comprises the individual's membership in a charitable organization, selecting the verification icon will present the user with information, such as “Confirmed by Joe Brown, President,” and/or “Member Since 1990, Currently Project Coordinator,” to inform the user how the individual's membership was verified. The profile field(s) or infoset(s) verified by the membership verified verification method may be unique to the organization and may have unique verification icons.

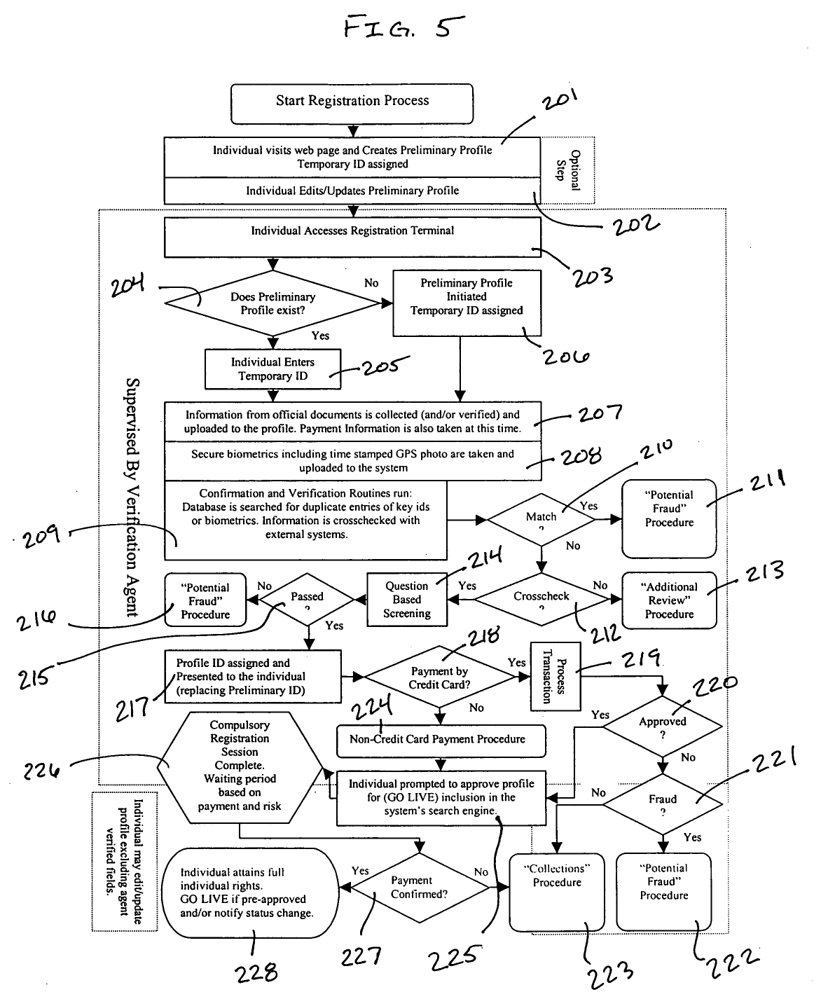

With reference to FIG. 5, an embodiment of the profile registration process, which includes the administration of at least one verification method, will be described. At step 201, an optional step, an individual uses a remote terminal 124 to visit a web page and create a preliminary profile. A temporary ID number is assigned to the individual. At step 202, also an optional step, the individual edits profile information and/or adds profile information to the preliminary profile using the remote terminal 124. At step 203, the individual accesses a registration terminal 122 at an authorized location. At step 204, the system or the agent determines whether a preliminary profile exists for the individual. If a preliminary profile does not exist, i.e., steps 201 and 202 were not performed, a preliminary profile is created, and a temporary ID number is assigned at step 206. If a preliminary profile does exist, the temporary ID number is entered into the registration terminal to retrieve the preliminary profile.

At step 207, information from official documents is collected and/or verified by the agent and uploaded to the profile. The agent may also collect payment information from the individual at step 207. At step 208, biometric information and a secure photo, which is GPS and time stamped, are taken from the individual and uploaded to the system. At step 209, the confirmation routine is executed to determine whether the profile contains key information that matches the key information contained in another profile previously uploaded to the profile database. At step 210, the system determines whether a match of key information was found. If a match was found, a fraud procedure is initiated at step 211. If no match was found, a crosscheck of external systems is executed at step 212. If the crosscheck procedure produced negative results, an additional review procedure is initiated at step 213. If the crosscheck procedure produced positive results, the question based screened verification method is administered at step 214.

If the individual does not pass the question based screened verification method, the fraud procedure is initiated at step 216. If the individual passes the question based screen verification method a (non-temporary) profile ID number is assigned and presented to the individual at step 217.

At steps 218-227, a payment confirmation procedure is performed to obtain payment from the individual. Once payment is confirmed at step 227, the individual is approved for registration in the opt-in directory system at step 228.

Searching for a Profile.

In accordance with the present invention, the opt-in directory system 120 (FIG. 1) comprises a search utility 136 on the server 132 for allowing a user to search the profile database 134 for profiles via the wide area network 126. The search utility 136 is configured to accept input from the user via a search GUI to create and submit a query and to present the user with search results.

The search utility 136 is configured to guide users through a comprehensive search experience designed to find an individual in as few steps as possible and with limited available information. In particular, the search utility 136 enables a user to find an individual based on information other than the individual's name, address, phone number, or SIN, which are typically required to locate individuals using conventional systems. In addition, because the profiles in the profile database 134 involve one vertical, namely, individuals, the layout and presentation of the profiles may be comprehensive and generally uniform, thus making it easy to gather useful information from the profiles.

The search utility 136 is configured to allow a user to perform a simple search and find a profile using the most basic profile information, such as name, gender, age range, phone number, citizenship, gender, and/or keywords. The search utility 136 is also configured to allow a user to perform an advanced search which may use existing natural language and artificial intelligence technologies to search the profile database 134 as well as specific fields using extensive logic.

The first step is for the user to create and submit the query by entering one or more search terms into the search GUI. Each search term has an associated search term category that describes the type of information included in the search term. If the query includes a narrow search term category, such as a phone number or an email address, the search utility 136 may present the user with only one profile listed in the search results. However, if the query only includes one or more broad search term categories, such as a country of residence or a gender designation, the search utility 136 will present the user with many profiles listed in the search results.

In one embodiment, the search utility 136 is configured to allow the user to designate a date range for a search term. For example, the user may wish to search for profiles that include “Accountant” in the occupation profile field for year 1996.

In another embodiment, the search utility 136 is configured to add synonymous search terms to the query that are synonymous with the search term entered by the user. The search utility 136 may also be configured to automatically correct spelling errors in search terms entered by the user and/or provide spelling alternatives and phonetic variations of search terms entered by the user.

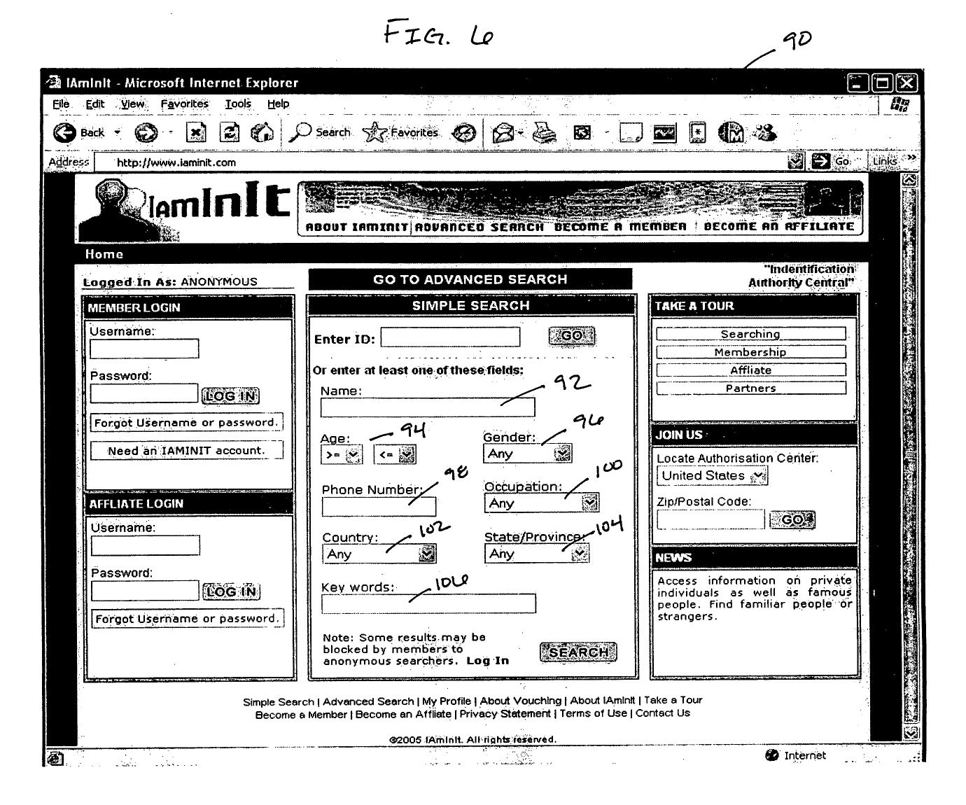

With reference to FIG. 6, one embodiment of the search GUI 90 is shown for accepting search terms from a user to create and submit a query. In the embodiment shown, the search terms may be entered into a name search field 92, an age search field 94, a gender search field 96, a phone number search field 98, an occupation search field 100, a country search field 102, a state/province search field 104, and/or a key words search field 106, wherein each search field is associated with the search term category that describes the type of information included in the search term.

After the user creates and submits the query and reviews the search results, the search utility 136 is configured to allow the user to create a refined query by changing and/or adding more search terms. In one embodiment, the search utility 136 is configured to present the user with at least one suggested search term category to use in the refined query. The suggested search term categories are derived by the search utility 136 based on the profile information contained in the profiles in the search results. The search utility 136 may allow the user to create a second refined query and a third refined query, etc., to further filter the search results and help in identifying the profiles desired by the user.

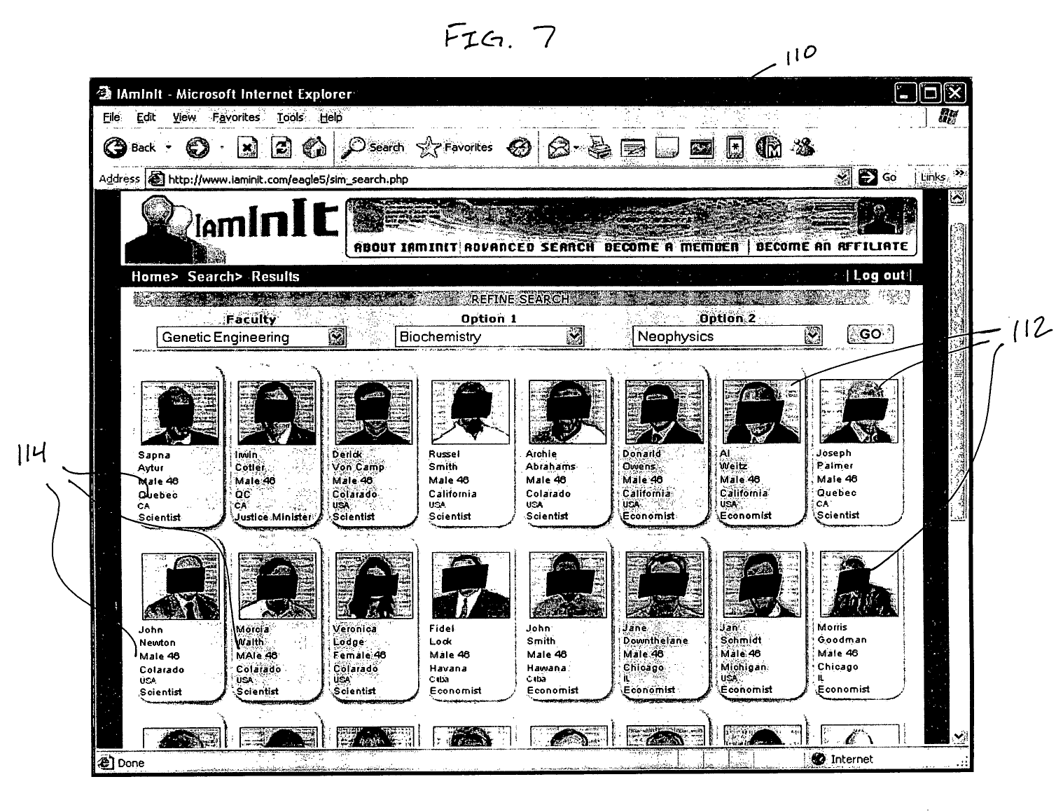

When the result of the iterative process filters the number of profiles in the search results to less than a results threshold, the search utility 136 presents the user with one or more thumbnail photos and/or one or more abridged profiles for each profile in the search results via a search results GUI. By selecting the thumbnail photo or the abridged profile, the user is allowed to access the profile. With reference to FIG. 7, one embodiment of a search results GUI 110 is shown for presenting the user with thumbnail photos 112 and abridged profiles 114 for each profile located by the search.

In another embodiment, the search utility 136 is configured to allow the user to create an advanced query by designating a preference for one or more search categories. For example, a user may create an advanced query for the five (5) profiles having the least degrees of separation from the user that include “Lawyer: Real Estate” in the occupation profile field and have a status of “Online” in a connected profile field, and set the preference for profiles that have a status of “Graphic Available” in a diploma profile field. Using the advanced query, if only three (3) profiles have a status of “Graphic Available” in the diploma profile field, the search results will also include two (2) profiles that include “Lawyer: Real Estate” in the occupation profile field and have a status of “Online” in the connected profile field but do not have a status of “Graphic .Available” in the diploma profile field.

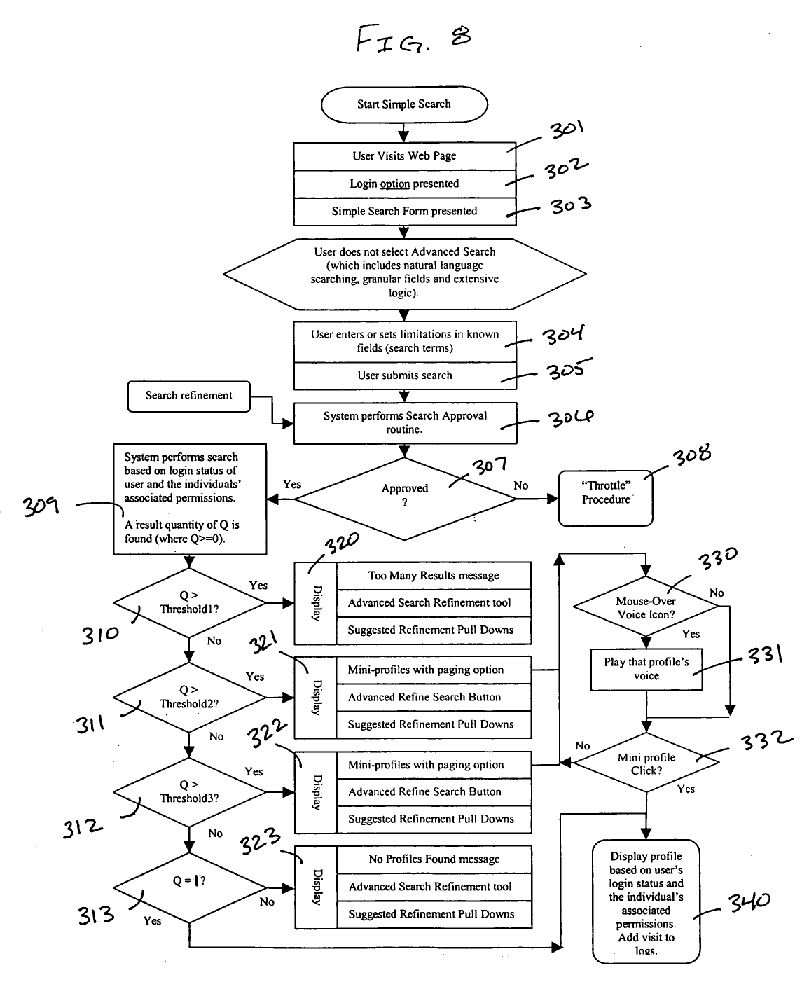

With reference to FIG. 8, an embodiment of the search process will be described. At step 301, the user visits a search web page hosted by the system via the wide area network. At step 302, a login GUI is presented to the user by the search utility for (optionally) logging into the system. At step 303, a simple search GUI is presented to the user. If the user does not select to perform an advanced search, the user enters search terms, which may comprise setting search limitations for profile fields, using the search GUI to create a search query at step 304. At step 305, the user submits the search query to the search utility via the network.

At step 306, the search utility performs a search approval routine. At step 307, the search utility determines whether the search query was approved by the search approval routine. If the search query was not approved, a throttle procedure is initiated at step 308. If the search query was approved, the search utility performs a search based on the login status of the user and the configuration of the individual profiles (e.g., access and display settings) in the database at step 309. Also at step 309, the search utility determines a quantity (“Q”) of individual profiles located as a result of the search.

At steps, 310-313, the search utility compares Q to a series of decreasing thresholds and displays the search results when Q is determined to be greater than a threshold in a manner suitable for viewing the number of individual profiles returned by the search. In particular, at step 310, the search utility determines whether Q is greater than a first threshold (a relatively high threshold). If Q is greater than the first threshold, a message is provided to the user that too many profiles were found by the search and an advanced search refinement tool and suggested refinement pull downs are presented to the user for refining the search at step 320. If Q is not greater than the first threshold, the search utility determines, at step 311, whether Q is greater than a second threshold (set at less than the first threshold).

If Q is greater than the second threshold, thumbnail photos and abridged profiles of the individual profiles located by the search are presented to the user (using one or more web pages or GUIs, with an option to page through all of the results), and an advanced search refinement tool and suggested refinement pull downs are presented to the user for refining the search at step 321. At step 330 and 331, the search utility plays a voice recording of an individual if that individual's profile includes a voice icon and if the user mouses over the voice icon. If the profile does not include a voice icon, or the user does not mouse over the voice icon, the system determines at step 332 whether the user has selected an abridged profile. If the user selects an abridged profile, the profile is displayed to the user based on the login status of the user and the configuration of the individual profiles (e.g., access and display settings) in the database, and a log of the user's access to the profile is created at step 340. If, at step 311, Q is not greater than the second threshold, the search utility determines, at step 312, whether Q is greater than a third threshold (set at less than the second threshold).

If Q is greater than the third threshold, thumbnail photos and abridged profiles of the individual profiles located by the search are presented to the user (using one or more web pages or GUIs, with an option to page through all of the results), and an advanced search refinement tool and suggested refinement pull downs are presented to the user for refining the search at step 322. At step 330 and 331, the search utility plays a voice recording of an individual if that individual's profile includes a voice icon and if the user mouses over the voice icon. If the profile does not include a voice icon, or the user does not mouse over the voice icon, the system determines at step 332 whether the user has selected an abridged profile. If the user selects an abridged profile, the profile is displayed to the user based on the login status of the user and the configuration of the individual profiles (e.g., access and display settings) in the database, and a log of the user's access to the profile is created at step 340. If, at step 312, Q is not greater than the third threshold, the search utility determines, at step 313, whether Q is equal to one (1).

If Q is equal to one (1), the one profile located by the search is displayed to the user based on the login status of the user and the configuration of the individual profiles (e.g., access and display settings) in the database, and a log of the user's access to the profile is created at step 340. If Q is not equal to one (1), a message is provided to the user that no individual profiles were found and an advanced search refinement tool and suggested refinement pull downs are presented to the user for refining the search at step 323.

In one embodiment, the third threshold is set to one (1) so that if only one profile is located by the search, the search utility will determine at step 312 that Q is not greater than the third threshold, the search utility will determine at step 313 that Q is equal to one (1), and the profile will be automatically displayed to the user at step 340. In another embodiment, wherein the user does not want to automatically view a profile and have such access logged by the system, the third threshold is set to zero (0) so that the search utility will determine at step 312 that Q is greater than the third threshold, thumbnail photos and abridged profiles of the individual profiles located by the search will be presented to the user (using one or more web pages or GUIs, with an option to page through all of the results), and an advanced search refinement tool and suggested refinement pull downs will be presented to the user for refining the search at step 322.

The search utility 136 (FIG. 1) of the present invention is configured to allow users to search the profile database 134 using a web browser as known in the art. The search utility 136 is configured to facilitate the presentation of dynamic forms which change based on the user's previous queries using Java applets or similar technology. A customized search GUI may be provided by the search utility 136 to allow users to search the profile database 134 using a media other than a web browser running on a PC running Internet Explorer, such as a cellular phone with limited display features.

In a still other embodiment, the search utility 136 is configured to throttle queries to prevent data mining by automated means. For example, the search utility 136 may be configured to limit the number of queries performed within a given number of seconds by a single IP address or compulsorily cookied computer.

In a further embodiment, the search utility 136 is configured to allow a user to access a profile directly, rather than by searching, via a URL (or web address). For example, the URL may comprise “http://www.iaminit.com/profile?id=brams10000000000” or “http://brams10000000000.iaminit.com,” where “brams10000000000” is the individual's profile ID number. Having a numerical component to the profile ID number alone would serve to identify the individual. However, including letters in the profile ID number adds a level of security that helps prevent data mining and makes the profile ID number easily identifiable as being associated with the opt-in directory system 120. In one embodiment, the numeric component would not be assigned to profile ID numbers sequentially so that most numbers would be unused. Further, the search utility 136 may be configured to expose and block random or brute force attempts to access profiles because such attempts would be disproportionably invalid.

Configuring Profiles for Access.

As previously described, the opt-in directory system 120 (FIG. 1) comprises a configuration utility 138 for allowing an individual to edit and configure his profile via the computer network 126. The configuration utility 138 provides the individual with administration GUIs for configuring the manner in which the profile is retrieved by the search utility 136 and displayed to users of the system 120. Accordingly, the opt-in directory system 120 provides individuals with control over their profile information to alleviate privacy concerns.

In one embodiment, the configuration utility 138 allows the individual to designate profile fields, and/or sets of profile fields, that, when the profile is located by the search utility 136 based on the designated profile fields and/or sets of profile fields, the profile will not be displayed by the search utility 136 in the search results.

The configuration utility 138 may also allow the individual to designate profile fields, and/or sets of profile fields, that, when the profile is located by the search utility 136 based on the designated profile fields and/or sets of profile fields, the profile will not be displayed by the search utility 136 in the search results unless the user is a member, or non-member, of a group. The individual defines the group based on characteristics of the user/searcher such as organization, degrees of separation, etc. The individual may choose to define many groups.

In another embodiment, the configuration utility 138 allows the individual to designate which profile fields, and/or which sets of profile fields, can be displayed to users that access the profile. The user may be notified that the individual's profile includes profile fields with information that is unavailable to the user. Further, the user may be provided with instructions on how the user can obtain the unavailable information, such as contact information for the individual or a request form.

The configuration utility 138 may allow the individual to designate which profile fields, and/or which sets of profile fields, can be displayed based on whether the user performing the search is a member of a group defined by the individual. The individual defines the group based on characteristics of the user/searcher such as organization, degrees of separation, etc. The individual may choose to define many groups. Each group defined by the individual represents those users to which the individual wishes to divulge more information. Thus, if the user is a member of the group defined by the individual, the user will be presented with additional information, namely, the information designated to be displayed to members and non-members of the group. Otherwise, the user will be presented with only the information designated to be displayed to non-members of the group.

For instance, the individual may define a group based simply on a collection of other specific users or based on a combination of several characteristics of users in general. Further, a group can be defined as a combination of other groups. In one embodiment, pre-defined groups are provided, such as General Merchants.

Accordingly, an individual could use the present invention to allow a user that is a member of a group, such as the General Merchants group, to retrieve the individual's profile by a query that includes the individual's credit card number and to display only the individual's secure photo and alias profile ID number to the user, whereas a user that is not a member of the group would not be able to retrieve the individual's profile using the individual's card number.

In one embodiment a group GUI is provided for defining groups. In another embodiment, each individual is provided one or more default groups such as “All,” defined as including all anonymous users and users logged into the system, or “Logged-in,” defined as all users logged into the system.

In one embodiment, the functionality of providing access to profiles is based on the INFO table (previously described) and five other tables within the profile database 134. The INFO table points to an INFO_GROUP table and in turn each entry points to a INFO_LOGIC_SEARCH table and a INFO_LOGIC_PRESENTATION table which define if the field may be searched and if the field may be presented based on a user's membership in groups contained in a USER_GROUP table. The USER_GROUP table points to a USER_LOGIC_GROUP table which allows entries in the USER_GROUP table to be used to create groups from other groups using advanced logic.

In accordance with this embodiment, the individual can control access to his profile information and the presentation of his profile information separately, depending on a user's group membership. If the user is not a member of a group that is restricted from searching by a particular profile field and is a member of at least one group that is allowed to search by the particular profile field, then the search will be allowed. If the user is not a member of a group that is restricted from having a particular profile field displayed and is a member of at least one group that is allowed to have the particular profile field displayed, then the field will be displayed. The individual can create as many groups as he needs. Given that changing the logic of one group will affect other groups, the group GUI can identify all affected groups and prompt the individual for approval before accepting a change request from the individual.

Because each individual is allowed to define his own groups, numerous different groups are possible and there is a chance that no users would qualify for a given group. In one embodiment, the configuration utility 138 provides the user with a shortcut for modifying a group. For example, the individual may be provided with a “Block Sender” button to block future communications from or access by a particular user.

In further embodiments, the configuration utility 138 allows the individual to designate and identify a preferred method of contact for users of the system that access his profile based on the users' membership in the individual's groups. The preferred method of contact may include, without limitation, (1) a public bulletin board or a blog where users can leave messages for everyone accessing the profile to see; (2) a controlled voice over IP (“VoIP”) link to different phone numbers or computers to provide cost savings and which may change dynamically based on where the individual is at the time or by a preset schedule; (3) a private web-based email so that the user would not be able to identify the individual's actual email address; or (4) text messaging or chat availability information. The individual may change the preferred method of contact any number of times.

Using the configuration utility 138 of the present invention, the individual is provided with considerable control over his profile to maximize its usefulness and, at the same time, protect his privacy. For example, the individual may not want his email address being mined by spammers, but won't mind if someone with his email address wants to learn more about him. Further, the same individual may want to allow potential employers or headhunters to see his email address and allow health specialists to see his medical records. Using the configuration utility 138, the individual is able to define a group and designate profile fields for display that meets these preferences.

The present invention thus provides an improved system and method for generating and accessing a verified individual profile, wherein the individual can control the manner in which his profile is accessed and the user can have confidence in the profile information.

Having thus described the invention in detail, it should be apparent that various modifications and changes may be made without departing from the spirit and scope of the present invention. Consequently, these and other modifications are contemplated to be within the spirit and scope of the following claims.

I claim:

1. An opt-in directory system on a wide area network comprising:
a. a registration terminal for entering data into a plurality of profile fields in a profile for an individual, wherein the data in at least one profile field is verified by an agent using a verification method;
b. a database for storing the profile; and
c. a search utility for allowing a user to search the database for the profile via the wide area network.

2. The opt-in directory system of claim 1, wherein the verification method is communicated to the user on a profile field by profile field basis.

3. The opt-in directory system of claim 1 further comprising:
a. a configuration utility for allowing the individual to edit and configure the profile via the wide area network.

4. The opt-in directory system of claim 3, wherein allowing the individual to configure the profile includes allowing the individual to designate which profile fields in the profile are displayed to the user.

5. The opt-in directory system of claim 1, wherein the verification method comprises the step of reviewing a government-issued identification document or card presented by the individual to the agent.

6. The opt-in directory system of claim 1, wherein the verification method comprises the step of asking the individual questions regarding an identity asserted by the individual to determine whether the identity is that of the individual.

7. The opt-in directory system of claim 1, wherein the verification method comprises the step of receiving electronic verification of the data from a third party.

8. The opt-in directory system of claim 1, wherein additional data is entered into at least a second profile field, the data in the at least second profile field is verified using a second verification method, and the second verification method comprises the step of receiving a vouch for the data regarding the individual from a voucher.

9. The opt-in directory system of claim 8, wherein the voucher is an affiliate of an organization and the information regarding the individual identifies the individual as a present or former member of the organization.

10. A method for generating and accessing a profile for an individual on a wide area network comprising the steps of:
a. entering data into a plurality of profile fields in the profile,
b. verifying the data in at least one profile field by an agent using a verification method;
c. storing the profile in a database; and
d. allowing a user to search the database for the profile via the wide area network.

11. A method as defined in claim 10, further comprising the step of communicating the verification method to the user on a profile field by a profile field basis.

12. A method as defined in claim 10, further comprising the step of allowing the individual to edit and configure the profile via the wide area network.

13. A method as defined in claim 12, wherein allowing the individual to configure the profile includes allowing the individual to designate which profile fields in the profile are displayed to the user.

14. A method as defined in claim 10, wherein the verification method comprises the step of reviewing a government-issued identification document or card presented by the individual to the agent.

15. A method as defined in claim 10, wherein the verification method comprises the step of asking the individual questions regarding an identity asserted by the individual to determine whether the identity is that of the individual.

16. A method as defined in claim 10, wherein the verification method comprises the step of receiving electronic verification of the data from a third party.

17. A method as defined in claim 10, further comprising the steps of:
a. entering additional data into at least a second profile field; and
b. verifying the data in the at least second profile field using a second verification method;
wherein the second verification method comprises the step of receiving a vouch for the data regarding the individual from a voucher.

18. A method as defined in claim 17, wherein the voucher is an affiliate of an organization and the information regarding the individual identifies the individual as a present or former member of the organization.

19. A method for preventing identity fraud using a directory system on a wide area network comprising the steps of:
a. receiving an identity from an individual;
b. obtaining a photograph of the individual or biometric information from the individual;
c. storing the photograph or biometric information on the directory system;
d. asking the individual questions regarding the identity to determine whether the identity is that of the individual; and
e. if the identity is not that of the individual, flagging the stored photograph or biometric information as having been received from a fraudulent individual.

20. A method for verifying the identity of an individual using a directory system on a wide area network comprising the steps of:
a. receiving information from the individual regarding an identity;
b. accessing a profile of the individual via the wide area network, wherein the profile is stored on the directory system and comprises a plurality of profile fields having data, and wherein the data in at least one profile field was verified using a verification method; and
c. comparing the verified data in the at least one profile field with the information received from the individual to determine whether the identity is that of the individual.

21. A method for allowing a user to search for and access individual profiles stored in a directory system on a wide area network comprising the steps of:
a. receiving a search query submitted by the user via the wide area network, wherein the search query comprises at least one search term;
b. providing the user with at least one individual profile, wherein the at least one individual profile comprises a plurality of profile fields having data, wherein the data in at least one profile field corresponds to the at least one search term, and wherein the data in at least one profile field was verified using a verification method;
c. providing the user with access to the at least one individual profile via the wide area network; and
d. communicating the verification method to the user on a field by field basis.

22. A method for verifying information in an individual profile stored in a directory system on a wide area network comprising the steps of:
a. receiving a search query submitted by a user via the wide area network, wherein the user has a user profile stored in the directory system and a user profile score associated with the user profile, and wherein the search query comprises at least one search term;
b. providing the user with at least one individual profile for an individual, wherein the at least one individual profile comprises a plurality of profile fields having data, wherein the data in at least one profile field corresponds to the at least one search term;
c. providing the user with access to the at least one individual profile via the wide area network;
d. allowing the user to create a vouch for data in at least one profile field in the accessed individual profile; and
e. assigning a trust score to the vouch, wherein the trust score is based on the user profile score.

23. A method for allowing an individual to configure a profile for access in a directory system on a wide area network comprising the steps of:
a. allowing the individual to define a search group and associate the search group with the profile, wherein the profile comprises a plurality of profile fields having data;
b. allowing the individual to designate at least one search profile field in the profile for displaying the profile only to members of the search group or for displaying the profile only to non-members of the search group;
c. receiving a search query submitted by a user via the wide area network, wherein the search query comprises at least one search term;
d. if the at least one search term corresponds to data in the at least one search profile field, determining whether the user is a member of the search group; and
e. if the user is a member of the search group, displaying the profile to the user if the at least one search profile field was designated for displaying the profile only to members of the search group or hiding the profile from the user if the at least one search profile field was designated for displaying the profile only to non-members of the search group.

24. A method as defined in claim 23, further comprising the steps of:
a. allowing the individual to define a display group and associate the display group with the profile;
b. allowing the individual to designate at least one display profile field in the profile for displaying the display profile field only to members of the display group or for displaying the display profile field only to non-members of the display group;
c. if the profile is displayed to the user, determining whether the user is a member of the display group; and
d. if the user is a member of the display group, displaying the at least one display profile field to the user if the at least one display profile field was designated for display only to members of the display group or hiding the at least one display profile field from the user if the at least one display profile field was designated for display only to non-members of the display group.

25. A method for allowing an individual to configure a profile for access in a directory system on a wide area network comprising the steps of:
a. allowing the individual to define a group and associate the group with the profile, wherein the profile comprises a plurality of profile fields having data;
b. allowing the individual to designate at least one designated profile field in the profile for display only to members of the group or for display only to non-members of the group;
c. receiving a search query submitted by a user via the wide area network, wherein the search query comprises at least one search term;
d. if the at least one search term corresponds to data in at least one profile field in the profile, allowing the user to view the profile;
e. determining whether the user is a member of the group; and
f. if the user is a member of the group, displaying the at least one designated profile field to the user if the at least one designated profile field was designated for display only to members of the group or hiding the at least one designated profile field from the user if the at least one designated profile field was designated for display only to non-members of the group.
